(19) United States
(12) Patent Application Publication
(10) Pub. No.: US 2024/0381204 A1
(43) Pub. Date: Nov. 14, 2024

(54) MOBILITY ENHANCEMENTS FOR DISASTER ROAMING DEVICES

(71) Applicant: Lenovo (Singapore) Pte. Ltd., New Tech Park (SG)

(72) Inventors: Hyung-Nam Choi, Ottobrunn (DE); Roozbeh Atarius, La Jolla, CA (US); Genadi Velev, Darmstadt (DE); Prateek Basu Mallick, Dreieich (DE); Ravi Kuchibhotla, Chicago, IL (US); Joachim Löhr, Wiesbaden (DE)

(21) Appl. No.: 18/683,153

(22) PCT Filed: Aug. 11, 2022
(86) PCT No.: PCT/IB2022/057520

§ 371 Date: Feb. 12, 2024

Related U.S. Application Data
(60) Provisional application No. 63/232,075, filed on Aug. 11, 2021.

(51) Int. Cl. H04W 36/08; H04W 4/90; H04W 36/36; H04W 48/18; H04W 48/20

(52) U.S. Cl. CPC H04W 36/08; H04W 36/362; H04W 48/18; H04W 48/20; H04W 4/90

(57) ABSTRACT

Apparatuses, methods, and systems are disclosed for mobility enhancements for disaster roaming devices. An apparatus (800) includes a transceiver (825) and a processor (805) coupled to the transceiver (825). The processor (805) is configured to cause the apparatus (800) to receive a first message comprising a configuration for selecting a suitable cell for disaster roaming, determine candidate cells and frequency layers for selecting the suitable cell according to the received configuration, and select the suitable cell for disaster roaming based on the determined candidate cells and frequency layers.

### CROSS-REFERENCE TO RELATED APPLICATIONS

This application claims the benefit of U.S. Provisional Patent Application No. 63/232,075, entitled “MOBILITY ENHANCEMENTS FOR DISASTER ROAMING DEVICES” and filed on Aug. 11, 2021, for Hyung-Nam Choi, et al., which is incorporated herein by reference.

### FIELD

The subject matter disclosed herein relates generally to wireless communications and more particularly relates to mobility enhancements for disaster roaming devices.

### BACKGROUND

In wireless networks, service requirements for minimizing service interruption address the use case in which a disaster condition (“DC”) applies to a public land mobile network (“PLMN”) or PLMNs in an area. It is assumed that in this case only the radio access network (“RAN”) part of the impacted PLMN(s) fails (e.g., core network (“CN”) part of the impacted PLMN(s) is still operational), so that all user equipments (“UEs”) located in the area of the impacted PLMN(s) will lose coverage. Thus, subject to regulatory requirements or operator's policy, to mitigate interruption of service for the impacted UEs, those UEs may be enabled to obtain service (e.g., voice call, mobile data service) from another PLMN(s) without a DC for the area where a DC applies.

### BRIEF SUMMARY

Disclosed are solutions for mobility enhancements for disaster roaming devices. The solutions may be implemented by apparatus, systems, methods, or computer program products.

In one embodiment, a first apparatus includes a transceiver and a processor coupled to the transceiver. In one embodiment, the processor is configured to cause the apparatus to receive a first message comprising a configuration for selecting a suitable cell for disaster roaming, determine candidate cells and frequency layers for selecting the suitable cell according to the received configuration, and select the suitable cell for disaster roaming based on the determined candidate cells and frequency layers.

In one embodiment, a first method receives a first message comprising a configuration for selecting a suitable cell for disaster roaming, determines candidate cells and frequency layers for selecting the suitable cell according to the received configuration, and selects the suitable cell for disaster roaming based on the determined candidate cells and frequency layers.

In one embodiment, a second apparatus includes a transceiver and a processor coupled to the transceiver. In one embodiment, the processor is configured to cause the apparatus to determine frequency layers on which disaster roaming service is offered, determine absolute frequency priority information for the determined frequency layers, and determine whether a disaster roaming device shall consider only cells which belong to the disaster roaming service area. In one embodiment, the processor is configured to cause the apparatus to transmit, via broadcast or dedicated signaling, a first message to one or more disaster roaming devices, the first message comprising a configuration for selecting a suitable cell for disaster roaming, the determined information about frequency layers on which disaster roaming service is offered, the determined absolute frequency priority information for the frequency layers on which disaster roaming service is offered, and the determined information about whether the disaster roaming device shall consider only cells which belong to the disaster roaming service area, the information in the first message transmitted commonly to communication networks or specifically to communication networks for which disaster condition applies.

In one embodiment, a second method determines frequency layers on which disaster roaming service is offered, determines absolute frequency priority information for the determined frequency layers, and determines whether a disaster roaming device shall consider only cells which belong to the disaster roaming service area. In one embodiment, the second method transmits, via broadcast or dedicated signaling, a first message to one or more disaster roaming devices, the first message comprising a configuration for selecting a suitable cell for disaster roaming, the determined information about frequency layers on which disaster roaming service is offered, the determined absolute frequency priority information for the frequency layers on which disaster roaming service is offered, and the determined information about whether the disaster roaming device shall consider only cells which belong to the disaster roaming service area, the information in the first message transmitted commonly to communication networks or specifically to communication networks for which disaster condition applies.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for mobility enhancements for disaster roaming devices;

FIG. 2 depicts a minimization of service interruption (“MINT”) use case for mobility enhancements for disaster roaming devices:

FIG. 3 depicts an example deployment of disaster roaming service area in PLMN A:

FIG. 4 depicts an example setting of cell reselection priorities by the network:

FIG. 5 depicts an example message flow of network-controlled handover in connected state:

FIG. 6 depicts a network deployment and setting of cell reselection priorities;

FIG. 7 is a diagram illustrating one embodiment of an NR protocol stack;

FIG. 8 is a block diagram illustrating one embodiment of a user equipment apparatus that may be used for mobility enhancements for disaster roaming devices;

FIG. 9 is a block diagram illustrating one embodiment of a network apparatus that may be used for mobility enhancements for disaster roaming devices;

FIG. 10 is a flowchart diagram illustrating one embodiment of a method for mobility enhancements for disaster roaming devices; and

FIG. 11 is a flowchart diagram illustrating one embodiment of another method for mobility enhancements for disaster roaming devices.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having,” and variations thereof mean “including but not limited to,” unless expressly specified otherwise. An enumerated listing of items does not imply that any or all of the items are mutually exclusive, unless expressly specified otherwise. The terms “a.” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more 20 of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for mobility enhancements for disaster roaming devices. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In Rel-17 new service requirements for minimizing service interruption are specified in 3GPP TS 22.261, which is incorporated herein in its entirety. The new service requirements address the use case in which a DC applies to a PLMN or PLMNs in an area. It is assumed that in this case only the RAN part of the impacted PLMN(s) fails (e.g., CN part of the impacted PLMN(s) is still operational), so that all UEs located in the area of the impacted PLMN(s) will lose coverage. Thus, subject to regulatory requirements or operator's policy, to mitigate interruption of service for the impacted UEs, those UEs shall be enabled to obtain service (e.g., voice call, mobile data service) from another PLMN(s) without DC for the area where a DC applies.

The embodiments below describe various solutions for mobility enhancements for disaster roaming devices. A first embodiment is directed to new conditions for cell suitability checks. In such an embodiment, for cell selection of a suitable cell in a PLMN without DC that provides disaster roaming service, the disaster roaming UE uses the new condition per default. In further embodiments, for cell reselection of a suitable cell in a PLMN without DC that provides disaster roaming service, the disaster roaming UE uses the new condition subject to network configuration. Thus, in one embodiment, the new condition is the cell is part of the disaster roaming service area that belongs to the selected PLMN.

A second embodiment is directed to new cell reselection priority information. In such an embodiment, for intra-frequency and inter-frequency cell reselection the network indicates per broadcast or dedicated signaling new cell reselection priority information. The network sends the new cell reselection priority information only for frequency layers on which disaster roaming service is provided and a disaster roaming UE considers only those frequency layers for cell reselection. In further embodiments, the new cell reselection priority information can be sent by network commonly for all PLMNs with DC or specifically to PLMNs with DC and includes an absolute cell reselection priority value and a subpriority value.

A third embodiment is directed to new parameters in measurement reporting configuration and measurement report. In such an embodiment, in the measurement reporting configuration in RRCReconfiguration or RRCResume message and for event-triggered or periodical measurements, the network can configure the UE to include the information whether the measured cell provides disaster roaming service. In further embodiments, in the MeasurementReport message, the UE sends new parameter to the network to indicate that the measured cell provides disaster roaming service.

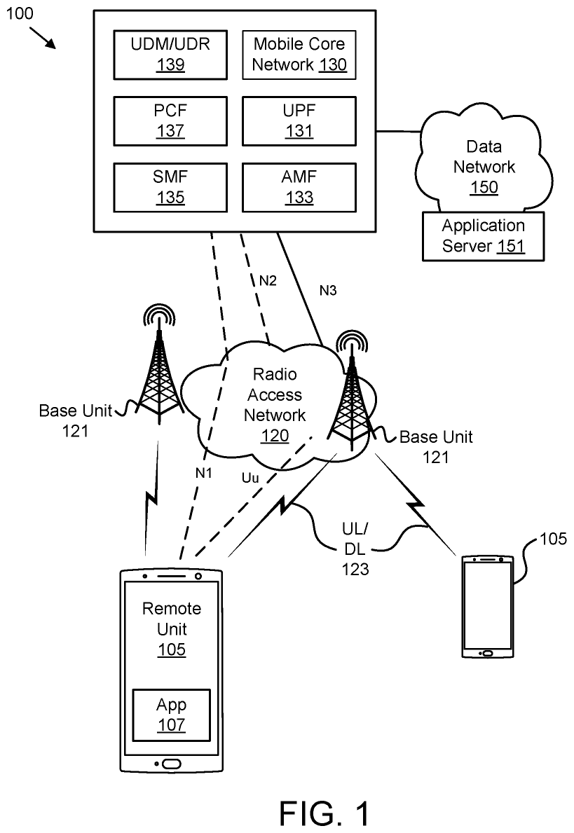

FIG. 1 depicts a wireless communication system 100 supporting mobility enhancements for disaster roaming devices, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 130 are depicted in FIG. 1, one of skill in the art will recognize that any number of remote units 105, base units 121, wireless communication links 123, RANs 120, and mobile core networks 130 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 130.

In some embodiments, the remote units 105 communicate with an application server via a network connection with the mobile core network 130. For example, an application 107 (e.g., web browser, media client, telephone and/or Voice-over-Internet-Protocol (“VOIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

To establish the PDU session (or PDN connection), the remote unit 105 must be registered with the mobile core network 130 (also referred to as ““attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5Q1”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single PLMN. The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”) a Policy Control Function (“PCF”) 137, a Unified Data Management function (“UDM”) and a User Data Repository (“UDR”).

The UPF(s) 131 is responsible for packet routing and forwarding, packet inspection, QoS handling, and external PDU session for interconnecting Data Network (“DN”), in the 5G architecture. The AMF 133 is responsible for termination of NAS signaling. NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF s responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting mobility enhancements for disaster roaming devices.

As background, in Rel-17 new service requirements for minimizing service interruption were specified in 3GPP TS 22.261. The new service requirements address the use case in which a disaster condition (DC) applies to a PLMN or PLMNs in an area. It is assumed that in this case only the RAN part of the impacted PLMN(s) fails (i.e., CN part of the impacted PLMN(s) is still operational), so that all UEs located in the area of the impacted PLMN(s) will lose coverage. Thus, subject to regulatory requirements or operator's policy, to mitigate interruption of service for the impacted UEs, those UEs shall be enabled to obtain service (e.g., voice call, mobile data service) from another PLMN(s) without DC for the area where a DC applies.

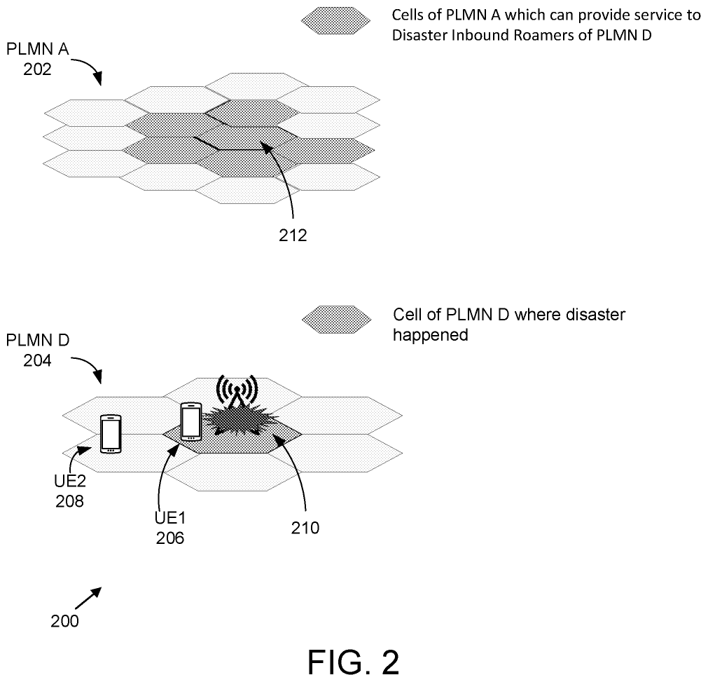

FIG. 2 depicts an example of the MINT use case in which two PLMNs (PLMN A 202, PLMN D 204) are impacted. DC applies to UE1 206 in an impacted area 210 of PLMN D 204 and PLMN A 202 without DC provides disaster roaming service. PLMN A 202 without DC is notified that DC applies to PLMN D 204 (e.g., by PLMN D 204 itself, operations, administration and maintenance (“OAM”), or regulator), and PLMN A 202 indicates to potential disaster inbound roamers of PLMN D 204 (in the following called “disaster roaming UEs”) whether they can access the PLMN A 204 in the concerned area 212, e.g., by broadcast signaling an indication that UEs of PLMN D 204 with DC are provided disaster roaming service.

After loss of coverage in the impacted area of PLMN D 204 and detection that DC applies to PLMN D 204, the UE1 206 selects PLMN A 202 although it is in UE1's 206 forbidden PLMN list since there are no other suitable PLMNs without DC available. The UE1 206 performs the NAS registration procedure to register to PLMN A 204. As part of the registration procedure, the AMF 133 in PLMN A 202 determines a registration area (“RA”) for UE1 206 such that the assigned tracking area (“TA”) list contains only those tracking area identities (“TAIs”) that overlap with the area of the disaster condition, e.g., the disaster roaming service area. If the disaster roaming UE1 206 leaves the disaster roaming service area due to mobility, then it has to leave PLMN A 204. Likewise, when the disaster roaming UE1 206 is notified by PLMN A 202 that DC is no longer applicable for PLMN D 204, the UE1 206 performs PLMN reselection in order to return to its home PLMN (“HPLMN”) or to its previous registered PLMN (e.g., visited PLMN (“VPLMN”)).

The stage 2 and stage 3 aspects of the service requirements for MINT have been studied in 3GPP, see latest TR 24.811, which is incorporated by reference herein in its entirety. And to specify the stage 2 functionality of the MINT feature based on the study, the Rel-17 work item SP-210582 was approved (which is incorporated by reference herein in its entirety). The stage 2 functionalities which are specified include:
Notification of Disaster Condition to the UE
Indication of accessibility from other PLMNs without Disaster Condition to the UE
Registration to the roaming PLMN without Disaster Condition in case of Disaster Condition
Notification that Disaster Condition is no longer applicable to the UEs
Prevention of signaling overload in PLMNs without Disaster Condition
Prevention of signaling overload by returning UEs in PLMN previously with Disaster Condition

However, in the current scope of the work item, further enhancements of UE operation while DC applies are not considered yet. For instance, depending on the deployment of the PLMN that provides disaster roaming service, mobility enhancements with regards to cell selection/reselection or handover of disaster roaming UEs within the disaster roaming service area may be beneficial.

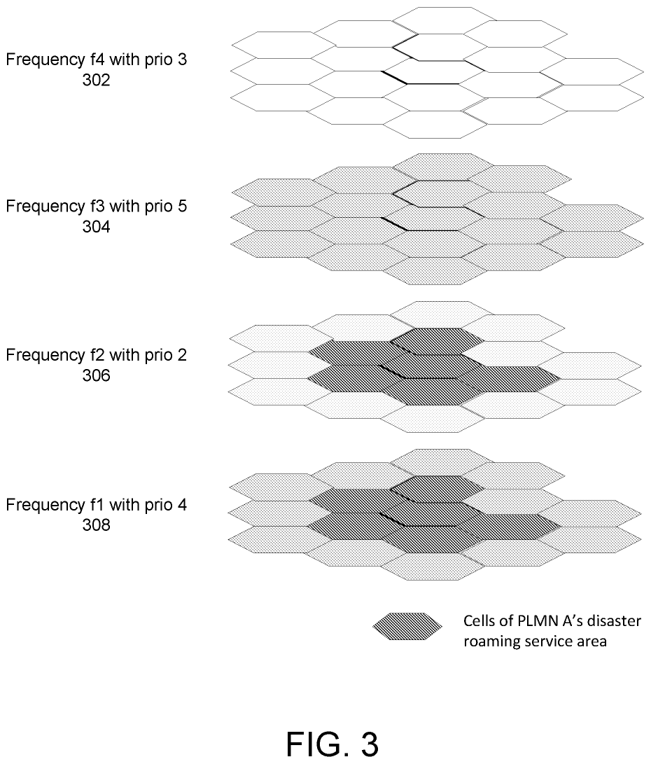

FIG. 3 shows an example deployment of disaster roaming service area in PLMN A that provides disaster roaming service. The disaster roaming service area consists of multiple cells, and may cover only a part of the UE's TAs and RA. It is assumed that PLMN A operates 4 frequency layers (f1 to f4) 302-308 for which different cell reselection priorities have been assigned for cell reselection. However, disaster roaming service is provided only on the frequency layers f1 308 and f2 306. PLMN A may vary the number of frequency layers on which disaster roaming service is provided depending on the number of PLMNs impacted by DC, the number of other PLMNs that provide disaster roaming service, and the number of disaster roaming UEs that are registered in its network. For instance, in case multiple PLMNs are impacted by DC and only PLMN A provides disaster roaming service and the number of registered disaster roaming UEs in PLMN A is high, then PLMN A may decide to provide disaster roaming service on all its frequency layers. But, in case only a single PLMN is impacted by DC and multiple other PLMNs provide disaster roaming service and the number of registered disaster roaming UEs in PLMN A is low or moderate, then PLMN A may decide to provide disaster roaming service only on a subset of its frequency layers.

While DC applies PLMN A should ensure that disaster roaming UEs stay in the disaster roaming service area as long as possible to be enabled to get service. However, if mobility would be performed according to NR Rel-16 specifications this may not be ensured. For instance, according to the specified cell reselection functionality based on absolute frequency priority information, disaster roaming UEs may reselect to a cell on a frequency layer on which no disaster roaming service is provided. If this case happens, then the UEs leave PLMN A by performing PLMN reselection in order to return to its HPLMN or to its previous registered PLMN (VPLMN). Furthermore, in case the number of registered disaster roaming UEs in PLMN A is high and multiple frequency layers provide disaster roaming service, then PLMN A should have additional means to flexibly control the mobility of the disaster roaming UEs on those frequency layers to avoid congestion.

To address the above cases, new solutions are needed for the PLMN without DC to flexibly control the mobility of the disaster roaming UEs in its network and to minimize the impacts on the non-disaster roaming UEs.

According to 3GPP NR Rel-16 specification TS 38.304, which is incorporated by reference herein in its entirety, the key characteristics of the specified cell selection functionality can be summarized as follows:
Cell selection is performed by the UE either i) as part of PLMN selection; ii) after transition from connected state/inactive state to idle state or from connected state to inactive state; iii) after RAT change in idle state, e.g., from NR to LTE; or iv) after return from out of coverage.
The UE searches for a suitable cell of the selected PLMN and RAT to camp on. A cell is considered as suitable if the following conditions are fulfilled:
   a. The cell is part of either the selected PLMN or the registered PLMN or PLMN of the Equivalent PLMN list.
   b. The cell selection criterion S is fulfilled, i.e., Srxlev>0 AND Squal>0. Srxlev describes the cell selection reception (“RX”) level value (in dB) and Squal describes the cell selection quality value (in dB).
   c. The cell is not barred.
   d. The cell is part of at least one TA that is not part of the list of “Forbidden Tracking Areas for Roaming,” which belongs to a PLMN that fulfils the first bullet a) above.
If cell selection is performed by the UE as part of PLMN selection and for NR RAT, it scans all RF channels in the NR bands according to its capabilities and for each frequency layer, it searches for and identifies the strongest cell. To determine whether the identified cell is a suitable cell, the UE reads SIB1 where the cell selection parameters for suitability check are signaled. If the UE has found a suitable cell, the UE selects it.
If cell selection is performed by the UE after transition to inactive state or idle state, the UE camps on a cell as result of cell selection according to the frequency assigned by radio resource control (“RRC”) in the state transition message if any.
Cell reselection priorities between different frequencies or RATs provided to the UE via system information or dedicated signaling are not used in the cell selection process.

According to 3GPP NR Rel-16 specifications TS 38.331 and TS 38.304, which are incorporated by reference herein in their entirety, network-assisted cell reselection is carried out by the UE in the idle and inactive states. The key characteristics of the specified cell reselection functionality can be summarized as follows:
Cell reselection is triggered in the UE after camping on a suitable cell and refers to the process in which the UE regularly searches for a more suitable cell of the selected PLMN to camp on.
Cell reselection is based on absolute frequency priority information:
   Those cell reselection priorities are provided by network via system information (“SI”) and dedicated signaling (RRC release message).
   A maximum of 8 priorities is defined for the purpose of inter-frequency and inter-RAT priority reselection; values are in the range from 0 to 7 with value 0=lowest priority and value 7=highest priority.
   For finer granularity so-called subpriorities in the value range={0.2, 0.4, 0.6, 0.8} can be optionally provided to each priority value.
   If priorities are provided in dedicated signaling, the UE ignores all the priorities provided in system information.
   The UE only performs cell reselection evaluation for NR frequencies and inter-RAT frequencies that are given in system information and for which a priority is provided.
For intra-frequency/inter-frequency/inter-RAT cell reselection, neighbor cells to evaluate or not to evaluate (given by physical layer cell identities) may be indicated in system information.
Cell reselection parameters (e.g., the offsets, thresholds, minimum required reception/quality levels, timers, or the like) are signaled by the network in the following system information blocks (“SIBs”):
   SIB2 contains cell reselection information common for intra-frequency, inter-frequency and/or inter-RAT cell reselection as well as intra-frequency cell reselection information other than neighboring cell related.
   SIB3 contains neighboring cell related information relevant only for intra-frequency cell reselection. It includes cells with specific reselection parameters as well as blacklisted cells.
   SIB4 contains information relevant for inter-frequency cell reselection, e.g., information about other NR frequencies and inter-frequency neighboring cells relevant for cell reselection.
   SIB5 contains information relevant only for inter-RAT cell reselection, e.g., information about E-UTRA (e.g., LTE) frequencies and E-UTRAs neighboring cells relevant for cell reselection.
For power saving purposes, the UE starts with evaluating (e.g., measuring) candidate cells for reselection only when at least one of the following cell reselection evaluation criterion is met:
   For every frequency layer of higher priority at least every T_{higher_priority_search}=(60*N_{layers}) seconds, where N_{layers} is the total number of higher priority NR and E-UTRA carrier frequencies broadcasted in system information
   For inter-frequency/inter-RAT frequency layers of equal, higher, or lower priority when Srxlev≤S_{nonIntraSearchP} AND Squal≤S_{nonIntraSearchQ}
   For intra-frequency layer when Srxlev≤ S_{IntraSearchP} AND Squal≤ S_{IntraSearchQ}.
As a result of the cell reselection evaluation process there may be multiple cells that may come into question as candidate cells for reselection. In this case, the UE applies the following cell reselection criteria and rules:
   The new cell is better than the serving cell according to the cell reselection criteria specified for intra-frequency, inter-frequency, or inter-RAT.
   Cell reselection criteria for higher priority NR or EUTRAN RAT/frequency:
      A cell of a higher priority NR or EUTRAN RAT/frequency fulfils Squal>Thresh_{X,HighQ} during a time interval Treselection_{RAT}
      A cell of a higher priority RAT/frequency fulfils Srxlev>Thresh_{X, HighP} during a time interval Treselection_{RAT}
   Cell reselection criteria for lower priority NR or EUTRAN RAT/frequency:
      The serving cell fulfils Squal<Thresh_{Serving,LowQ} and a cell of a lower priority NR or E-UTRAN RAT/frequency fulfils Squal>Thresh_{X, LowQ} during a time interval Treselection_{RAT}
      The serving cell fulfils Srxlev<Thresh_{Serving,LowP} and a cell of a lower priority RAT/frequency fulfils Srxlev>Thresh_{X,LowP} during a time interval Treselection_{RAT}
   Cell reselection criteria for intra-frequency and equal priority inter-frequency cells: For the measured intra-frequency and equal priority inter-frequency cells, the cells are ranked using the cell ranking criterion Rₛ and Rₙ as defined by

Serving cell: Rₛ=+Q_{meas,s}+Q_{hyst}−Qoffsetₜₑₘₚ

Neighbor cell: Rₙ=Q_{meas,n}−Qoffset−Qoffsetₜₑₘₚ
Cell reselection to a higher priority RAT/frequency shall take precedence over a lower priority RAT/frequency if multiple cells of different priorities fulfil the cell reselection criteria.
For intra-frequency/inter-frequency cell reselection the UE selects the highest ranked cell, otherwise the strongest cell for inter-RAT cell reselection.

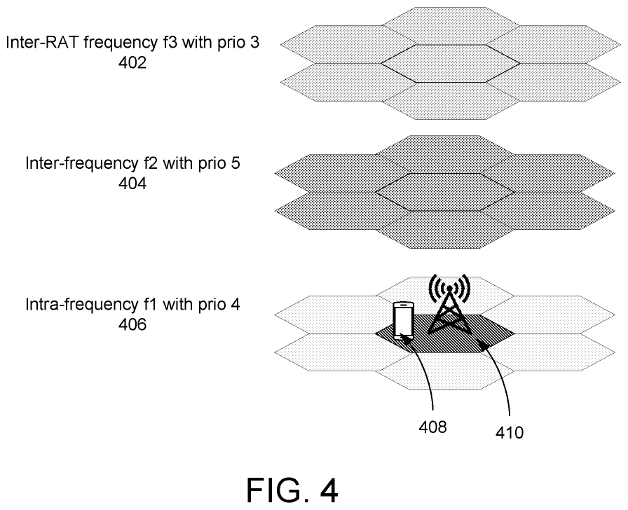

FIG. 4 shows an example setting of the cell reselection priorities that are provided by the network via system information or dedicated signaling. In the example shown in FIG. 4, 3 frequency layers are assumed (1 NR intra-frequency 406, 1 NR inter-frequency 404, and 1 LTE inter-RAT frequency 402). The inter-frequency f2 404 has the highest priority and the inter-RAT frequency f3 402 has the lowest frequency. The UE 408 is camped on the suitable cell 410 on the intra-frequency f1 406. The UE 408 starts with evaluating the candidate cells for reselection and reselects to a suitable cell on the concerned frequency layer in accordance with the specified criteria.

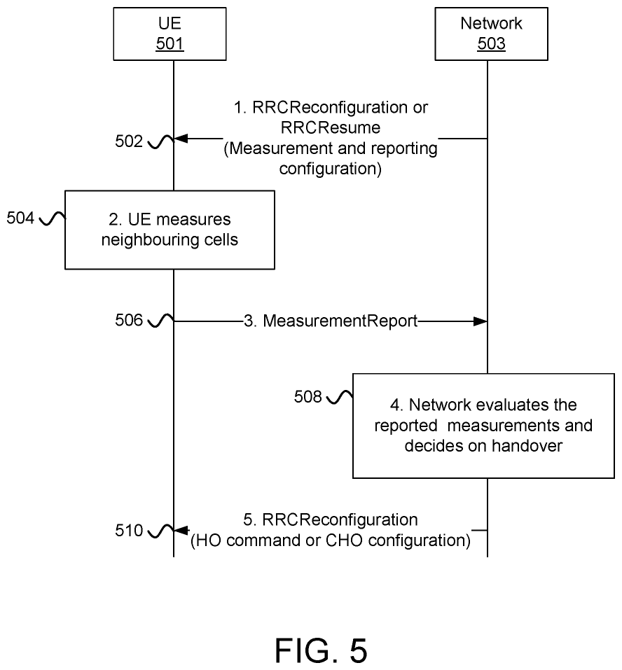

According to 3GPP NR Rel-16 specification TS 38.331, which is incorporated by reference herein in its entirety, a network-controlled handover (“HO”) is performed. The key characteristics of the HO functionality, as shown in FIG. 5, can be summarized as follows:
Step 1 (see messaging 502): A UE 501 in connected state is configured by the network 503 to measure and report neighboring cells. The UE 501 may receive the measurement and reporting configuration from the network either via the DL RRCReconfiguration or DL RRCResume message.
Steps 2/3 (see block 504 and messaging 506): In accordance with the received measurement and reporting configuration the UE 501 measures neighboring cells and reports the cells which fulfil the measurement criteria (measurement object, thresholds, periodical or event-based triggering, cells to measure etc.). The measurement results are sent by the UE 501 to the network via the UL MeasurementReport message.
Steps 4/5 (see block 508 and messaging 510): Based on the reported measurements the network 503 evaluates whether to perform HO, e.g., depending on the mobility of the UE 501 or the network load in source cell and candidate target cells. If the network 503 decides to perform HO, then it sends to the UE 501 the HO command via the DL RRCReconfiguration message. The HO command includes the cell identity and all information required for the UE 501 to access the target cell. Alternatively, if both the network 503 and the UE 501 support conditional handover (“CHO”), then the network 503 sends an RRCReconfiguration message to the UE 501 containing the configuration of CHO candidate cell(s) and CHO execution condition(s). The UE 501 executes HO to a CHO candidate cell that meets the execution condition(s).

The following solutions are proposed to enable the PLMN without DC that provides disaster roaming service to flexibly control the mobility of the disaster roaming UEs in its network and to minimize the impacts on the non-disaster roaming UEs.

In one embodiment, new conditions for cell suitability check are described:
In one embodiment, for cell selection of a suitable cell in a PLMN without DC that provides disaster roaming service, the disaster roaming UE shall consider a cell as suitable if the following conditions are fulfilled:
   a. The cell is part of the selected PLMN, e.g., the PLMN without DC that provides disaster roaming service for the UEs of the PLMN impacted by DC in which the UEs were previously registered;
   b. The cell selection criterion S is fulfilled, e.g., Srxlev>0 AND Squal>0;
   c. The cell is not barred; and
   e. The cell is part of the disaster roaming service area which belongs to the selected PLMN.
In one embodiment, for cell reselection of a suitable cell in a PLMN without DC that provides disaster roaming service, the disaster roaming UE shall consider a cell as suitable if following conditions are fulfilled:
   The cell is part of the selected PLMN, e.g., the PLMN without DC that provides disaster roaming service for the UEs of the PLMN impacted by DC in which the UEs were previously registered;
   The cell selection criterion S is fulfilled, e.g., Srxlev>0 AND Squal>0;
   The cell is not barred; and
   The applicability of the condition whether the cell is part of the disaster roaming service area that belongs to the selected PLMN is subject to network configuration. If the network indicates per broadcast (in an existing or new SIB) or dedicated signaling (e.g., RRCRelease message) whether the disaster roaming UE shall use the determination of whether the cell is part of the disaster roaming service area that belongs to the selected PLMN for cell suitability check, e.g., by setting the new field “cellSuitabilityCheckForDConly” with value “enabled.” If this field is not set by the network, then the disaster roaming UE shall not use the condition whether the cell is part of the disaster roaming service area that belongs to the selected PLMN for cell suitability check. In this case the disaster roaming UE shall consider a cell as suitable even if it does not provide disaster roaming service. The network may not set the new field when it wants to apply a staggered approach for triggering the disaster roaming UEs to leave the network when DC does not apply for a PLMN anymore, e.g., to avoid congestion in the PLMN previously with DC when mass of UEs return to it. In this case, it firstly deconfigures the use of the new condition whether the cell is part of the disaster roaming service area that belongs to the selected PLMN, then after some time it removes the indication that disaster roaming service is offered for the concerned PLMN. This new field “cellSuitabilityCheckForDConly” may be sent by network commonly for all PLMNs with DC or specifically to PLMNs with DC for which disaster roaming service is provided.

Regarding new cell reselection priority information:
In one embodiment, for intra-frequency and inter-frequency cell reselection, the network indicates per broadcast (e.g., SIB2 and/or SIB4) or dedicated signaling (e.g., RRCRelease message) new cell reselection priority information, e.g., by the field “cellSelectionPriorityInfoForDC.”
   In case of broadcast signaling and for intra-frequency cell reselection, the new field is sent in SIB2.
   In case of broadcast signaling and for inter-frequency cell reselection, the new field is sent in SIB4 for a configured frequency layer.
   Alternatively, the new cell reselection priority information for intra-frequency and inter-frequency cell reselection can be signaled in a new system information block (“SIB”).
   In case of dedicated signaling, the new field is sent in the RRCRelease message for a configured NR frequency layer.
   The network sends the new cell reselection priority information only in cells that are part of the disaster roaming service area and only for frequency layers on which disaster roaming service is provided. A disaster roaming UE considers only those frequency layers for cell reselection.
In one embodiment, the new cell reselection priority information can be sent by the network commonly for all PLMNs with DC or specifically to PLMNs with DC for which disaster roaming service is provided and includes the following parameters:
   An absolute cell reselection priority value in the range from 0 to 7 with value 0=lowest priority and value 7=highest priority.
   For finer granularity, a subpriority value in the value range={0.2, 0.4, 0.6, 0.8} can be optionally provided to each priority value.
   In contrary to legacy priority values, multiple or all frequency layers can be assigned with the same priority values. For frequency layers with equal priority the disaster roaming UE can randomly select a frequency layer for cell reselection.
   The new cell reselection priorities may be set differently for PLMNs with DC for which disaster roaming service is provided, e.g., in accordance with the number of registered disaster roaming UEs. For instance, if the number of registered UEs from a PLMN D1 is higher than from a PLMN D2 then the network may decide to prioritize certain frequencies for PLMN D1 UEs.
If the new field “cellSelectionPriorityInfoForDC” is received, then the disaster roaming UE applies the new cell reselection priority information instead of the legacy cell reselection priority information. If the new field is not sent, then the disaster roaming UE applies the legacy cell reselection priority information.

Regarding new parameters in measurement reporting configuration and measurement report, in one embodiment:
In the measurement reporting configuration (e.g., IE ReportConfigNR) in RRCReconfiguration or RRCResume message, for event-triggered or periodical measurements, the network can configure the UE to include the information whether the measured cell provides disaster roaming service.
In the MeasurementReport message (e.g., IE MeasResultListNR), the UE sends a new parameter to the network to indicate that the measured cell provides disaster roaming service. This parameter may contain a simple indication (“TRUE”) or a list of PLMNs with DC for which disaster roaming service is provided.
Based on the measurement reporting configuration received from the network the disaster roaming UE performs the measurements and reports the measured results to the network. And in accordance with the received measurement results the network performs the handover of the disaster roaming UE to an appropriate candidate target cell.
This solution addresses the case in which the disaster roaming service area consists of multiple cells which are served by different gNBs. The gNBs may not know whether neighbor cells served by other gNBs provide disaster roaming service or not. Based on the new indication received from the disaster roaming UE, the source gNB may try to HO the UE to a target gNB that provides disaster roaming service while DC applies. If this cannot be fulfilled due to mobility of the UE, then the source gNB may HO the UE to a target gNB that does not provide disaster roaming service or keep it in the source gNB until radio link failure occurs. When DC does not apply anymore for a PLMN previously with DC, then the source gNB may HO the UE to any neighbor cell.

Although the proposed solutions and the described embodiments in the following focus on NR RAT connected to 5GC, they are principally applicable to E-UTRA RAT connected to 5GC as well.

A first embodiment is directed to initial cell selection in a PLMN without DC that provides disaster roaming service. In this embodiment, the deployments as shown in FIG. 2 and FIG. 3 are referenced and the following are assumed:
A disaster happened in an impacted area 210 of PLMN D 204, DC applies to PLMN D 204, and UE1 206 is in the impacted area.
UE1 206 supports the MINT feature and is configured by its HPLMN to use disaster roaming service if DC applies in HPLMN or VPLMN. For disaster roaming service UE1 206 considers only PLMNs which are listed in its forbidden PLMN list.
PLMN A without DC 202 provides disaster roaming service in the concerned area 212 and on the frequency layers f1 308 and f2 306.

In one embodiment, after loss of coverage in the impacted area 210 of PLMN D 204 and detection that DC applies to PLMN D 204, UE1 206 tries to find a suitable PLMN without DC to register on among the PLMNs in its forbidden PLMN list. UE1 206 finds PLMN A 202 as suitable PLMN that provides disaster roaming service to UEs of PLMN D 204 (e.g., by reading the concerned information which are broadcast by the cells of the disaster roaming service area in PLMN A 202). Since no other suitable PLMNs without DC have been found, UE1 206 selects PLMN A 202 and tries to camp on a suitable cell of PLMN A 202.

In this context, UE1 206 applies the conditions “a”, “b”, “c” and “e” for cell suitability check, namely that the cell is part of the selected PLMN, e.g., the PLMN without DC that provides disaster roaming service for the UEs of the PLMN impacted by DC in which the UEs were previously registered; the cell selection criterion S is fulfilled, e.g., Srxlev>0 AND Squal>0; the cell is not barred; and the cell is part of the disaster roaming service area which belongs to the selected PLMN. As a result, UE1 206 has found candidate cells on frequency layers f1 308 and f2 306. UE1 randomly selects frequency layer f1 308 and the strongest cell therein. UE1 206 performs the NAS registration procedure to register with PLMN A 202.

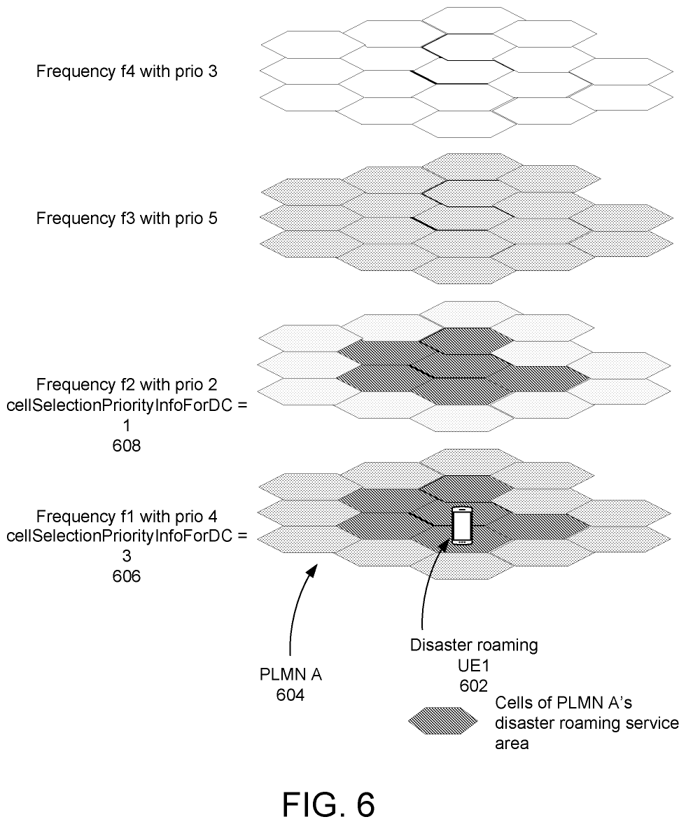

A second embodiment is directed to cell reselection of a disaster roaming UE. In this embodiment, the network deployment and setting of cell reselection priorities in PLMN A as shown in FIG. 6 is assumed. The disaster roaming UE1 602 is registered in PLMN A 604, in idle state and camped on a cell on the frequency layer f1 606 and which provides disaster roaming service. DC still applies in PLMN D and the serving cell of UE1 broadcasts the following special configurations for disaster roaming UEs:
In SIB2 for cell reselection: cellSuitability Check ForDConly=“enabled”.
In SIB2 for the intra-frequency serving cell on frequency layer f1 606: cellSelection Priority InfoForDC=3.
In SIB4 for the inter-frequency cells on frequency layer f2 608: cellSelectionPriorityInfoForDC=1

In one embodiment, in accordance with the received configuration, UE1 602 applies the conditions “a”, “b”, “c” and “e” for cell suitability check, namely that the cell is part of the selected PLMN, e.g., the PLMN without DC that provides disaster roaming service for the UEs of the PLMN impacted by DC in which the UEs were previously registered; the cell selection criterion S is fulfilled, e.g., Srxlev>0 AND Squal>0; the cell is not barred; and the cell is part of the disaster roaming service area which belongs to the selected PLMN, and the new cell reselection priority information instead of the legacy cell reselection priority information. UE1 602 starts with evaluating candidate cells for reselection on the concerned frequency layers f1 606 and f2 608 when the following criteria are met:
For inter-frequency layer f2 when

$$Srxlev \leq {S}_{nonIntraSearchP} AND Squal \leq {S}_{nonIntraSearchQ}$$

For intra-frequency layer f1 when

$$Srxlev \leq {S}_{IntraSearchP} AND Squal \leq {S}_{IntraSearchQ}$$

In one embodiment, UE1 602 considers only candidate cells for reselection when they provide disaster roaming service and reselects to a cell in accordance with the cell reselection criteria for intra-frequency and lower priority inter-frequency cells. In one embodiment, non-disaster roaming UEs that are registered in PLMN A are not impacted by the special configurations for disaster roaming UEs and apply the legacy rules for cell reselection and legacy settings of cell reselection priorities.

A third embodiment is directed to measurement reporting configuration and measurement report of a disaster roaming UE. In this embodiment, the deployments as shown in FIG. 2 and FIG. 3 are referenced. The disaster roaming UE1 206 is registered in PLMN A 202, in connected state and served by a cell on the frequency layer f1 308 and which provides disaster roaming service. For connected state mobility, the network performs the message flow as shown and described above with reference to FIG. 5. A particular example of the message flow of FIG. 5 is described below, with reference to FIGS. 2 and 3:
Step 1: In one embodiment, the disaster roaming UE1 206 is configured by the network to measure and report neighboring cells. UE1 206 receives the measurement and reporting configuration from the network via the RRCReconfiguration message. It is assumed that in the measurement reporting configuration (IE ReportConfigNR) and for event-triggered measurements the UE1 206 has been configured to include the information whether the measured cell provides disaster roaming service.
Step 2/3: In one embodiment, in accordance with the received measurement and reporting configuration, UE1 206 measures neighboring cells and reports the cells that fulfil the measurement criteria (measurement object, thresholds, periodical or event-based triggering, cells to measure, and/or the like). The measurement results are sent by UE1 206 to the network via the MeasurementReport message. It is assumed that the measurement report contains measurements of cells on all 4 frequency layers f1 to f4 302-308 and cells inside and outside of the configured disaster roaming service area. For each measured cell on f1 308 and f2 306 and which is part of the configured disaster roaming service area, the measurement report contains the information that the measured cell provides disaster roaming service, e.g., by using a simple indication (“TRUE”).
Step 4/5: In one embodiment, based on the reported measurements, the network evaluates whether to perform HO, e.g., depending on the mobility of the UE1 206 or the network load in source cell and candidate target cells. If the network decides to perform HO and DC still applies for PLMN D 204, then it sends to the UE1 206 the HO command or CHO configuration via the RRCReconfiguration message including only candidate target cell(s) on the frequency layers f1 308 and/or f2 306 and which provide disaster roaming service.

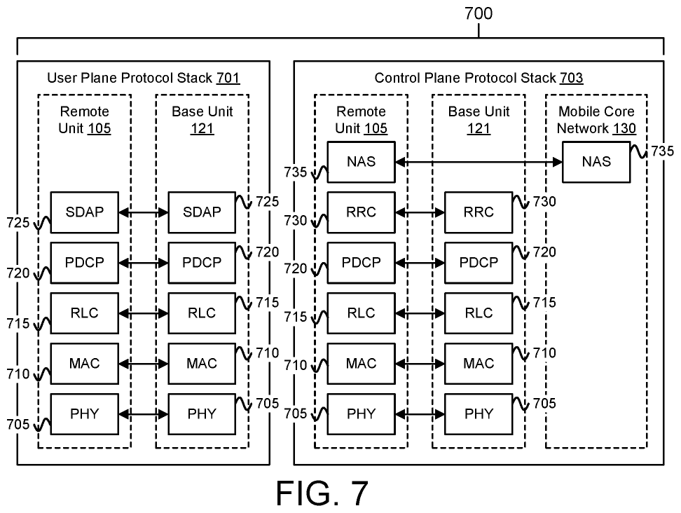

FIG. 7 depicts an NR protocol stack 700, according to embodiments of the disclosure. While FIG. 7 shows the remote unit 105, the base unit 121 and the mobile core network 130, these are representative of a set of UEs interacting with a RAN node and an NF (e.g., AMF) in a core network. As depicted, the protocol stack 700 comprises a User Plane protocol stack 701 and a Control Plane protocol stack 703. The User Plane protocol stack 701 includes a physical (“PHY”) layer 705, a Medium Access Control (“MAC”) sublayer 710, a Radio Link Control (“RLC”) sublayer 715, a Packet Data Convergence Protocol (“PDCP”) sublayer 720, and Service Data Adaptation Protocol (“SDAP”) sublayer 725. The Control Plane protocol stack 703 also includes a physical layer 705, a MAC sublayer 710, a RLC sublayer 715, and a PDCP sublayer 720. The Control Place protocol stack 703 also includes an RRC sublayer 730 and a Non-Access Stratum (“NAS”) sublayer 735.

The AS protocol stack for the Control Plane protocol stack 703 consists of at least RRC, PDCP, RLC and MAC sublayers, and the physical layer. The AS protocol stack for the User Plane protocol stack 701 consists of at least SDAP, PDCP, RLC and MAC sublayers, and the physical layer. The Layer-2 (“12”) is split into the SDAP, PDCP, RLC and MAC sublayers. The Layer-3 (“L3”) includes the RRC sublayer 730 and the NAS sublayer 735 for the control plane and includes, e.g., an Internet Protocol (“IP”) layer or PDU Layer (not depicted) for the user plane. L1 and L2 are referred to as “lower layers”, while L3 and above (e.g., transport layer, application layer) are referred to as “higher layers” or “upper layers” such as RRC.

The physical layer 705 offers transport channels to the MAC sublayer 710. The MAC sublayer 710 offers logical channels to the RLC sublayer 715. The RLC sublayer 715 offers RLC channels to the PDCP sublayer 720. The PDCP sublayer 720 offers radio bearers to the SDAP sublayer 725 and/or RRC sublayer 730. The SDAP sublayer 725 offers QOS flows to the mobile core network 130 (e.g., 5GC). The RRC sublayer 730 provides for the addition, modification, and release of Carrier Aggregation and/or Dual Connectivity. The RRC sublayer 730 also manages the establishment, configuration, maintenance, and release of Signaling Radio Bearers (“SRBs”) and Data Radio Bearers (“DRBs”). In certain embodiments, an RRC entity functions for detection of and recovery from radio link failure.

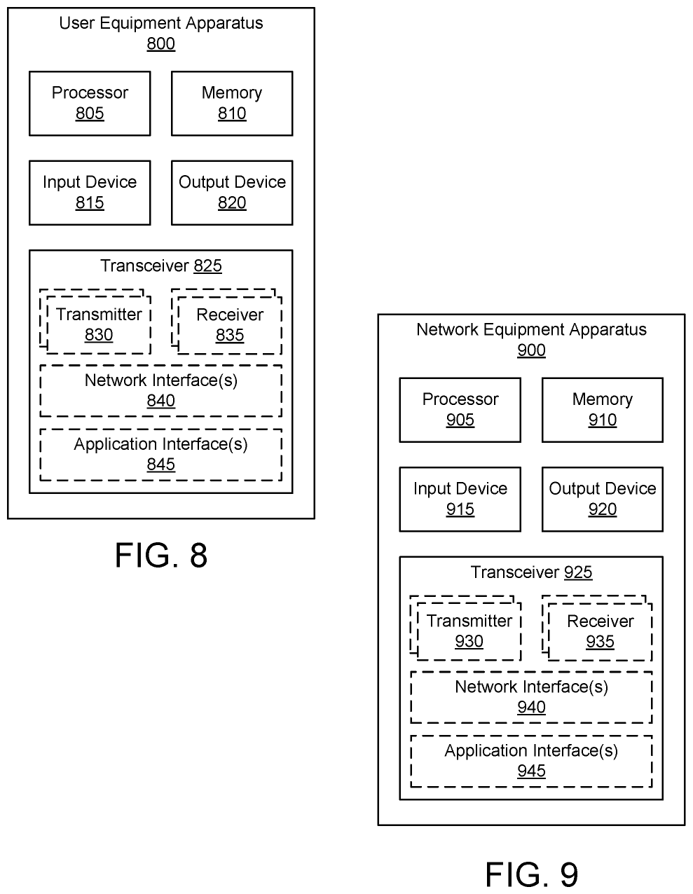

FIG. 8 depicts a user equipment apparatus 800 that may be used for mobility enhancements for disaster roaming devices, according to embodiments of the disclosure. In various embodiments, the user equipment apparatus 800 is used to implement one or more of the solutions described above. The user equipment apparatus 800 may be one embodiment of a UE, such as the remote unit 105 and/or the UE as described above. Furthermore, the user equipment apparatus 800 may include a processor 805, a memory 810, an input device 815, an output device 820, and a transceiver 825. In some embodiments, the input device 815 and the output device 820 are combined into a single device, such as a touchscreen. In certain embodiments, the user equipment apparatus 800 may not include any input device 815 and/or output device 820. In various embodiments, the user equipment apparatus 800 may include one or more of: the processor 805, the memory 810, and the transceiver 825, and may not include the input device 815 and/or the output device 820.

As depicted, the transceiver 825 includes at least one transmitter 830 and at least one receiver 835. Here, the transceiver 825 communicates with one or more base units 121. Additionally, the transceiver 825 may support at least one network interface 840 and/or application interface 845. The application interface(s) 845 may support one or more APIs. The network interface(s) 840 may support 3GPP reference points, such as Uu and PC5. Other network interfaces 840 may be supported, as understood by one of ordinary skill in the art.

The processor 805, in one embodiment, may include any known controller capable of executing computer-readable instructions and/or capable of performing logical operations. For example, the processor 805 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825. In certain embodiments, the processor 805 may include an application processor (also known as “main processor”) which manages application-domain and operating system (“OS”) functions and a baseband processor (also known as “baseband radio processor”) which manages radio functions.

The memory 810, in one embodiment, is a computer readable storage medium. In some embodiments, the memory 810 includes volatile computer storage media. For example, the memory 810 may include a RAM, including dynamic RAM (“DRAM”), synchronous dynamic RAM (“SDRAM”), and/or static RAM (“SRAM”). In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data related to mobility enhancements for disaster roaming devices. For example, the memory 810 may store parameters, configurations, resource assignments, policies, and the like as described above. In certain embodiments, the memory 810 also stores program code and related data, such as an operating system or other controller algorithms operating on the user equipment apparatus 800, and one or more software applications.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, is designed to output visual, audible, and/or haptic signals. In some embodiments, the output device 820 includes an electronically controllable display or display device capable of outputting visual data to a user. For example, the output device 820 may include, but is not limited to, an LCD display, an LED display, an OLED display, a projector, or similar display device capable of outputting images, text, or the like to a user. As another, non-limiting, example, the output device 820 may include a wearable display separate from, but communicatively coupled to, the rest of the user equipment apparatus 800, such as a smart watch, smart glasses, a heads-up display, or the like. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all, or portions of the output device 820 may be integrated with the input device 815. For example, the input device 815 and output device 820 may form a touchscreen or similar touch-sensitive display. In other embodiments, the output device 820 may be located near the input device 815.

The transceiver 825 includes at least one transmitter 830 and at least one receiver 835. The transceiver 825 may be used to provide UL communication signals to a base unit 121 and to receive DL communication signals from the base unit 121, as described herein. Similarly, the transceiver 825 may be used to transmit and receive SL signals (e.g., V2X communication), as described herein. Although only one transmitter 830 and one receiver 835 are illustrated, the user equipment apparatus 800 may have any suitable number of transmitters 830 and receivers 835. Further, the transmitter(s) 830 and the receiver(s) 835 may be any suitable type of transmitters and receivers. In one embodiment, the transceiver 825 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 825, transmitters 830, and receivers 835 may be implemented as physically separate components that access a shared hardware resource and/or software resource, such as for example, the network interface 840.

In various embodiments, one or more transmitters 830 and/or one or more receivers 835 may be implemented and/or integrated into a single hardware component, such as a multi-transceiver chip, a system-on-a-chip, an ASIC, or other type of hardware component. In certain embodiments, one or more transmitters 830 and/or one or more receivers 835 may be implemented and/or integrated into a multi-chip module. In some embodiments, other components such as the network interface 840 or other hardware components/circuits may be integrated with any number of transmitters 830 and/or receivers 835 into a single chip. In such embodiment, the transmitters 830 and receivers 835 may be logically configured as a transceiver 825 that uses one more common control signals or as modular transmitters 830 and receivers 835 implemented in the same hardware chip or in a multi-chip module.

In one embodiment, the processor 805 receives, via the transceiver 825, a first message comprising a configuration for selecting a suitable cell for disaster roaming, determine candidate cells and frequency layers for selecting the suitable cell according to the received configuration, and select the suitable cell for disaster roaming based on the determined candidate cells and frequency layers.

In one embodiment, the first message further comprises information about frequency layers on which disaster roaming service is offered, absolute frequency priority information for the frequency layers on which disaster roaming service is offered, and information about whether the disaster roaming device shall consider only cells that belong to a disaster roaming service area.

In one embodiment, the information in the first message is transmitted commonly for a plurality of communication networks or specifically to communication networks for which a disaster condition applies.

In one embodiment, the first message is transmitted using broadcast or dedicated signaling in a cell on which disaster roaming service is offered.

In one embodiment, the configuration comprises cell reselection priority information for intra-frequency and inter-frequency cell reselection.

In one embodiment, for broadcast signaling, the processor 805, for intra-frequency cell reselection, receives a new field comprising the cell reselection priority information in SIB2, and for inter-frequency cell reselection, receives a new field comprising the cell reselection priority information in SIB4 for a configured frequency layer.

In one embodiment, the cell reselection priority information is received in a new SIB for intra-frequency and inter-frequency cell reselection.

In one embodiment, for dedicated signaling, the processor 805 receives a new field in an RRCRelease message for a configured frequency layer.

In one embodiment, the cell reselection priority information comprises a cell reselection priority value within a predefined range for each of a plurality of frequency layers.

In one embodiment, the cell reselection priority information comprises a subpriority value within a predefined range of the priority value for each of the plurality of frequency layers.

In one embodiment, the same priority values can be assigned to multiple of the plurality of frequency layers.

In one embodiment, the processor 805 randomly selects a frequency layer of a plurality of frequency layers that have the same priority value for cell reselection.

In one embodiment, the cell reselection priority value is assigned to each of the plurality of frequency layers according to a number of registered disaster roaming UE devices.

FIG. 9 depicts one embodiment of a network apparatus 900 that may be used for mobility enhancements for disaster roaming devices, according to embodiments of the disclosure. In some embodiments, the network apparatus 900 may be one embodiment of a RAN node and its supporting hardware, such as the base unit 121 and/or gNB, described above. Furthermore, network apparatus 900 may include a processor 905, a memory 910, an input device 915, an output device 920, and a transceiver 925. In certain embodiments, the network apparatus 900 does not include any input device 915 and/or output device 920.

As depicted, the transceiver 925 includes at least one transmitter 930 and at least one receiver 935. Here, the transceiver 925 communicates with one or more remote units 105. Additionally, the transceiver 925 may support at least one network interface 940 and/or application interface 945. The application interface(s) 945 may support one or more APIs. The network interface(s) 940 may support 3GPP reference points, such as Uu, N1, N2, N3, N5, N6 and/or N7 interfaces. Other network interfaces 940 may be supported, as understood by one of ordinary skill in the art.

When implementing a NEF, the network interface(s) 940 may include an interface for communicating with an application function (i.e., N5) and with at least one network function (e.g., UDR, SMF, UPF, or the like) in a mobile communication network, such as the mobile core network 130.

The processor 905, in one embodiment, may include any known controller capable of executing computer-readable instructions and/or capable of performing logical operations. For example, the processor 905 may be a microcontroller, a microprocessor, a CPU, a GPU, an auxiliary processing unit, an FPGA, a DSP, a co-processor, an application-specific processor, or similar programmable controller. In some embodiments, the processor 905 executes instructions stored in the memory 910 to perform the methods and routines described herein. The processor 905 is communicatively coupled to the memory 910, the input device 915, the output device 920, and the transceiver 925. In certain embodiments, the processor 905 may include an application processor (also known as “main processor”) which manages application-domain and OS functions and a baseband processor (also known as “baseband radio processor”) which manages radio function. In various embodiments, the processor 905 controls the network apparatus 900 to implement the above described network entity behaviors (e.g., of the gNB) for mobility enhancements for disaster roaming devices.

The memory 910, in one embodiment, is a computer readable storage medium. In some embodiments, the memory 910 includes volatile computer storage media. For example, the memory 910 may include a RAM, including DRAM, SDRAM, and/or SRAM. In some embodiments, the memory 910 includes non-volatile computer storage media. For example, the memory 910 may include a hard disk drive, a flash memory, or any other suitable non-volatile computer storage device. In some embodiments, the memory 910 includes both volatile and non-volatile computer storage media.

In some embodiments, the memory 910 stores data related to mobility enhancements for disaster roaming devices. For example, the memory 910 may store parameters, configurations, resource assignments, policies, and the like as described above. In certain embodiments, the memory 910 also stores program code and related data, such as an OS or other controller algorithms operating on the network apparatus 900, and one or more software applications.

The input device 915, in one embodiment, may include any known computer input device including a touch panel, a button, a keyboard, a stylus, a microphone, or the like. In some embodiments, the input device 915 may be integrated with the output device 920, for example, as a touchscreen or similar touch-sensitive display. In some embodiments, the input device 915 includes a touchscreen such that text may be input using a virtual keyboard displayed on the touchscreen and/or by handwriting on the touchscreen. In some embodiments, the input device 915 includes two or more different devices, such as a keyboard and a touch panel.

The output device 920, in one embodiment, may include any known electronically controllable display or display device. The output device 920 may be designed to output visual, audible, and/or haptic signals. In some embodiments, the output device 920 includes an electronic display capable of outputting visual data to a user. Further, the output device 920 may be a component of a smart phone, a personal digital assistant, a television, a table computer, a notebook (laptop) computer, a personal computer, a vehicle dashboard, or the like.

In certain embodiments, the output device 920 includes one or more speakers for producing sound. For example, the output device 920 may produce an audible alert or notification (e.g., a beep or chime). In some embodiments, the output device 920 includes one or more haptic devices for producing vibrations, motion, or other haptic feedback. In some embodiments, all, or portions of the output device 920 may be integrated with the input device 915. For example, the input device 915 and output device 920 may form a touchscreen or similar touch-sensitive display. In other embodiments, all, or portions of the output device 920 may be located near the input device 915.

As discussed above, the transceiver 925 may communicate with one or more remote units and/or with one or more interworking functions that provide access to one or more PLMNs. The transceiver 925 may also communicate with one or more network functions (e.g., in the mobile core network 130). The transceiver 925 operates under the control of the processor 905 to transmit messages, data, and other signals and also to receive messages, data, and other signals. For example, the processor 905 may selectively activate the transceiver (or portions thereof) at particular times in order to send and receive messages.

The transceiver 925 may include one or more transmitters 930 and one or more receivers 935. In certain embodiments, the one or more transmitters 930 and/or the one or more receivers 935 may share transceiver hardware and/or circuitry. For example, the one or more transmitters 930 and/or the one or more receivers 935 may share antenna(s), antenna tuner(s), amplifier(s), filter(s), oscillator(s), mixer(s), modulator/demodulator(s), power supply, and the like. In one embodiment, the transceiver 925 implements multiple logical transceivers using different communication protocols or protocol stacks, while using common physical hardware.

In one embodiment, the processor 905 determines frequency layers on which disaster roaming service is offered, determines absolute frequency priority information for the determined frequency layers, and determines whether a disaster roaming device shall consider only cells which belong to the disaster roaming service area. In one embodiment, the processor 905 transmits, via broadcast or dedicated signaling using the transceiver 925, a first message to one or more disaster roaming devices, the first message comprising a configuration for selecting a suitable cell for disaster roaming, the determined information about frequency layers on which disaster roaming service is offered, the determined absolute frequency priority information for the frequency layers on which disaster roaming service is offered, and the determined information about whether the disaster roaming device shall consider only cells which belong to the disaster roaming service area, the information in the first message transmitted commonly to communication networks or specifically to communication networks for which disaster condition applies.

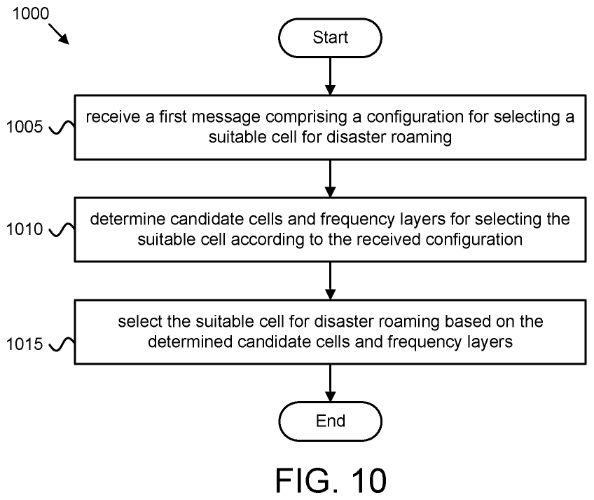

FIG. 10 is a flowchart diagram of a method 1000 for mobility enhancements for disaster roaming devices. The method 1000 may be performed by a UE as described herein, for example, the remote unit 105 and/or the user equipment apparatus 800. In some embodiments, the method 1000 may be performed by a processor executing program code, for example, a microcontroller, a microprocessor, a CPU, a GPU, an auxiliary processing unit, a FPGA, or the like.

In one embodiment, the method 1000 begins and receives 1005 a first message comprising a configuration for selecting a suitable cell for disaster roaming. In one embodiment, the method 1000 determines 1010 candidate cells and frequency layers for selecting the suitable cell according to the received configuration. In one embodiment, the method 1000 selects 1015 the suitable cell for disaster roaming based on the determined candidate cells and frequency layers, and the method 1000 ends.

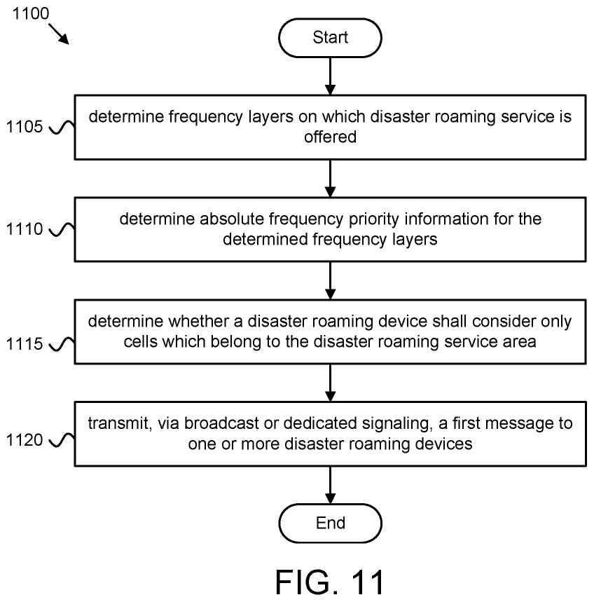

FIG. 11 is a flowchart diagram of a method 1100 for mobility enhancements for disaster roaming devices. The method 1100 may be performed by a network entity as described herein, for example, the gNB, the base unit 121, and/or the network equipment apparatus 900. In some embodiments, the method 1100 may be performed by a processor executing program code, for example, a microcontroller, a microprocessor, a CPU, a GPU, an auxiliary processing unit, a FPGA, or the like.

In one embodiment, the method 1100 begins and determines 1105 frequency layers on which disaster roaming service is offered. In one embodiment, the method 1100 determines 1110 absolute frequency priority information for the determined frequency layers. In one embodiment, the method 1100 determines 1115 whether a disaster roaming device shall consider only cells which belong to the disaster roaming service area. In one embodiment, the method 1100 transmits 1120, via broadcast or dedicated signaling, a first message to one or more disaster roaming devices, and the method 1100 ends.

A first apparatus is disclosed for mobility enhancements for disaster roaming devices. The first apparatus may include a UE as described herein, for example, the remote unit 105 and/or the user equipment apparatus 800. In some embodiments, the first apparatus includes a processor executing program code, for example, a microcontroller, a microprocessor, a CPU, a GPU, an auxiliary processing unit, a FPGA, or the like.

In one embodiment, the first apparatus includes a transceiver and a processor coupled to the transceiver. In one embodiment, the processor is configured to cause the apparatus to receive a first message comprising a configuration for selecting a suitable cell for disaster roaming, determine candidate cells and frequency layers for selecting the suitable cell according to the received configuration, and select the suitable cell for disaster roaming based on the determined candidate cells and frequency layers.

In one embodiment, the first message further comprises information about frequency layers on which disaster roaming service is offered, absolute frequency priority information for the frequency layers on which disaster roaming service is offered, and information about whether the disaster roaming device shall consider only cells that belong to a disaster roaming service area.

In one embodiment, the information in the first message is transmitted commonly for a plurality of communication networks or specifically to communication networks for which a disaster condition applies.

In one embodiment, the first message is transmitted using broadcast or dedicated signaling in a cell on which disaster roaming service is offered.

In one embodiment, the configuration comprises cell reselection priority information for intra-frequency and inter-frequency cell reselection.

In one embodiment, for broadcast signaling, the processor is configured to cause the apparatus to, for intra-frequency cell reselection, receive a new field comprising the cell reselection priority information in SIB2, and for inter-frequency cell reselection, receive a new field comprising the cell reselection priority information in SIB4 for a configured frequency layer.

In one embodiment, the cell reselection priority information is received in a new SIB for intra-frequency and inter-frequency cell reselection.

In one embodiment, for dedicated signaling, the processor is configured to cause the apparatus to receive a new field in an RRCRelease message for a configured frequency layer.

In one embodiment, the cell reselection priority information comprises a cell reselection priority value within a predefined range for each of a plurality of frequency layers.

In one embodiment, the cell reselection priority information comprises a subpriority value within a predefined range of the priority value for each of the plurality of frequency layers.

In one embodiment, the same priority values can be assigned to multiple of the plurality of frequency layers.

In one embodiment, the processor is configured to cause the apparatus to randomly select a frequency layer of a plurality of frequency layers that have the same priority value for cell reselection.

In one embodiment, the cell reselection priority value is assigned to each of the plurality of frequency layers according to a number of registered disaster roaming UE devices.

A first method is disclosed for mobility enhancements for disaster roaming devices. The first method may be performed by a UE as described herein, for example, the remote unit 105 and/or the user equipment apparatus 800. In some embodiments, the first method may be performed by a processor executing program code, for example, a microcontroller, a microprocessor, a CPU, a GPU, an auxiliary processing unit, a FPGA, or the like.

In one embodiment, the first method receives a first message comprising a configuration for selecting a suitable cell for disaster roaming, determines candidate cells and frequency layers for selecting the suitable cell according to the received configuration, and selects the suitable cell for disaster roaming based on the determined candidate cells and frequency layers.

In one embodiment, the first message further comprises information about frequency layers on which disaster roaming service is offered, absolute frequency priority information for the frequency layers on which disaster roaming service is offered, and information about whether the disaster roaming device shall consider only cells that belong to a disaster roaming service area.

In one embodiment, the information in the first message is transmitted commonly for a plurality of communication networks or specifically to communication networks for which a disaster condition applies.

In one embodiment, the first message is transmitted using broadcast or dedicated signaling in a cell on which disaster roaming service is offered.

In one embodiment, the configuration comprises cell reselection priority information for intra-frequency and inter-frequency cell reselection.

In one embodiment, for broadcast signaling, the first method, for intra-frequency cell reselection, receives a new field comprising the cell reselection priority information in SIB2, and for inter-frequency cell reselection, receives a new field comprising the cell reselection priority information in SIB4 for a configured frequency layer.

In one embodiment, the cell reselection priority information is received in a new SIB for intra-frequency and inter-frequency cell reselection.

In one embodiment, for dedicated signaling, the first method receives a new field in an RRCRelease message for a configured frequency layer.

In one embodiment, the cell reselection priority information comprises a cell reselection priority value within a predefined range for each of a plurality of frequency layers.

In one embodiment, the cell reselection priority information comprises a subpriority value within a predefined range of the priority value for each of the plurality of frequency layers.

In one embodiment, the same priority values can be assigned to multiple of the plurality of frequency layers.

In one embodiment, the first method randomly selects a frequency layer of a plurality of frequency layers that have the same priority value for cell reselection.

In one embodiment, the cell reselection priority value is assigned to each of the plurality of frequency layers according to a number of registered disaster roaming UE devices.

A second apparatus is disclosed for mobility enhancements for disaster roaming devices. The second apparatus may include a network entity as described herein, for example, the gNB, the base unit 121, and/or the network equipment apparatus 900. In some embodiments, the second apparatus may include a processor executing program code, for example, a microcontroller, a microprocessor, a CPU, a GPU, an auxiliary processing unit, a FPGA, or the like.

In one embodiment, the second apparatus includes a transceiver and a processor coupled to the transceiver. In one embodiment, the processor is configured to cause the apparatus to determine frequency layers on which disaster roaming service is offered, determine absolute frequency priority information for the determined frequency layers, and determine whether a disaster roaming device shall consider only cells which belong to the disaster roaming service area. In one embodiment, the processor is configured to cause the apparatus to transmit, via broadcast or dedicated signaling, a first message to one or more disaster roaming devices, the first message comprising a configuration for selecting a suitable cell for disaster roaming, the determined information about frequency layers on which disaster roaming service is offered, the determined absolute frequency priority information for the frequency layers on which disaster roaming service is offered, and the determined information about whether the disaster roaming device shall consider only cells which belong to the disaster roaming service area, the information in the first message transmitted commonly to communication networks or specifically to communication networks for which disaster condition applies.

A second method is disclosed for mobility enhancements for disaster roaming devices. The second method may be performed by a network entity as described herein, for example, the gNB, the base unit 121, and/or the network equipment apparatus 900. In some embodiments, the second method may be performed by a processor executing program code, for example, a microcontroller, a microprocessor, a CPU, a GPU, an auxiliary processing unit, a FPGA, or the like.

In one embodiment, the second method determines frequency layers on which disaster roaming service is offered, determines absolute frequency priority information for the determined frequency layers, and determines whether a disaster roaming device shall consider only cells which belong to the disaster roaming service area. In one embodiment, the second method transmits, via broadcast or dedicated signaling, a first message to one or more disaster roaming devices, the first message comprising a configuration for selecting a suitable cell for disaster roaming, the determined information about frequency layers on which disaster roaming service is offered, the determined absolute frequency priority information for the frequency layers on which disaster roaming service is offered, and the determined information about whether the disaster roaming device shall consider only cells which belong to the disaster roaming service area, the information in the first message transmitted commonly to communication networks or specifically to communication networks for which disaster condition applies.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (“UE”) apparatus, comprising:
a transceiver; and
a processor coupled to the transceiver, the processor configured to cause the apparatus to:
receive a first message comprising a configuration for selecting a suitable cell for disaster roaming;
determine candidate cells and frequency layers for selecting the suitable cell according to the received configuration; and
select the suitable cell for disaster roaming based on the determined candidate cells and frequency layers.

2. The apparatus of claim 1, wherein the first message further comprises:
information about frequency layers on which disaster roaming service is offered;
absolute frequency priority information for the frequency layers on which disaster roaming service is offered; and
information about whether the disaster roaming device shall consider only cells that belong to a disaster roaming service area.

3. The apparatus of claim 2, wherein the information in the first message is transmitted commonly for a plurality of communication networks or specifically to communication networks for which a disaster condition applies.

4. The apparatus of claim 1, wherein the first message is transmitted using broadcast or dedicated signaling in a cell on which disaster roaming service is offered.

5. The apparatus of claim 1, wherein the configuration comprises cell reselection priority information for intra-frequency and inter-frequency cell reselection.

6. The apparatus of claim 5, wherein, for broadcast signaling, the processor is configured to cause the apparatus to:
for intra-frequency cell reselection, receive a new field comprising the cell reselection priority information in SIB2; and
for inter-frequency cell reselection, receive a new field comprising the cell reselection priority information in SIB4 for a configured frequency layer.

7. The apparatus of claim 5, wherein the cell reselection priority information is received in a new SIB for intra-frequency and inter-frequency cell reselection.

8. The apparatus of claim 5, wherein, for dedicated signaling, the processor is configured to cause the apparatus to receive a new field in an RRCRelease message for a configured frequency layer.

9. The apparatus of claim 5, wherein the cell reselection priority information comprises a cell reselection priority value within a predefined range for each of a plurality of frequency layers.

10. The apparatus of claim 9, wherein the cell reselection priority information comprises a subpriority value within a predefined range of the priority value for each of the plurality of frequency layers.

11. The apparatus of claim 9, wherein the same priority values can be assigned to multiple of the plurality of frequency layers.

12. The apparatus of claim 11, wherein the processor is configured to cause the apparatus to randomly select a frequency layer of a plurality of frequency layers that have the same priority value for cell reselection.

13. The apparatus of claim 5, wherein the cell reselection priority value is assigned to each of the plurality of frequency layers according to a number of registered disaster roaming UE devices.

14. A method of a user equipment (“UE”) apparatus, comprising:
receiving a first message comprising a configuration for selecting a suitable cell for disaster roaming;
determining candidate cells and frequency layers for selecting the suitable cell according to the received configuration; and
selecting the suitable cell for disaster roaming based on the determined candidate cells and frequency layers.

15. A network equipment apparatus, comprising:
a transceiver; and
a processor coupled to the transceiver, the processor configured to cause the apparatus to:
determine frequency layers on which disaster roaming service is offered;
determine absolute frequency priority information for the determined frequency layers;
determine whether a disaster roaming device shall consider only cells which belong to the disaster roaming service area; and
transmit, via broadcast or dedicated signaling, a first message to one or more disaster roaming devices, the first message comprising a configuration for selecting a suitable cell for disaster roaming, the determined information about frequency layers on which disaster roaming service is offered, the determined absolute frequency priority information for the frequency layers on which disaster roaming service is offered, and the determined information about whether the disaster roaming device shall consider only cells which belong to the disaster roaming service area, the information in the first message transmitted commonly to communication networks or specifically to communication networks for which disaster condition applies.
